(19) United States
(12) Patent Application Publication
(10) Pub. No.: US 2004/0030597 A1
(43) Pub. Date: Feb. 12, 2004

(54) Method and system of optimizing the response and profitability of a marketing program

(75) Inventor: Gregory M. Bibas, New Canaan, CT (US)

Correspondence Address: Charles N. J. Ruggiero, Esq., Ohlandt, Greeley, Ruggiero & Perle, L.L.P., One Landmark Square, 10th Floor, Stamford, CT, 06901-2682, US

(73) Assignee: RealHome.com

(21) Appl. No.: 10/429,219

(22) Filed: May 2, 2003

Related U.S. Application Data
(60) Provisional application No. 60/377,913, filed on May 3, 2002.

(51) Int. Cl. G06F 17/60

(52) U.S. Cl. 705/14

(57) ABSTRACT

A method and system for capturing customer information and/or behavioral data that may include, for example, the day/time/date of the visit, the location on the site, channel or other electronic media property, demographic information including physical location, ad format data, as well as partner coding information. The method and system passes such information, to an analyzer which determines which advertising unit to a display device, and what follow-up sales process will be used. The system and method also includes capturing the customer action information, and continuously analyzing such information against pre-determined rule-sets to determine whether a decision should be made to remove such advertising unit from the advertising marketing mix.

### BACKGROUND OF THE INVENTION

1. Field of the Invention

The present invention relates to a process for optimizing the results of a marketing program. In particular, the present invention relates to a method and a system for capturing response information, analyzing results of multiple variations of marketing formats, automatically selecting a version to optimize the results of a marketing program, and producing result data on marketing tests that are statistically significant, as defined by the user.

2. Description of the Related Art

In traditional direct response marketing and online marketing, human intervention is required to analyze response and/or sales conversion results, prior to optimizing the performance and/or profitability of a marketing program or campaign based upon that analysis. Adjustments to marketing mix, pricing, formats, marketing creatives used, and/or strategic direction within such a marketing campaign are based upon the ability of those who manage such programs to quickly analyze results, test alternatives, and compare results.

Online marketing campaigns typically provide for and include tracking HTML links, pixels or other programming code to allow individuals monitoring program performance to calculate the pertinent program response and sales conversion metrics such as email open rate, banner, impression, link and/or email click rate, and sales page sign-up or sales conversion. Such programming codes allow for unique monitoring and calculating of results, and real-time analysis, and form the basis for the technological infrastructure of many online referral management, or affiliate programs.

There are also systems that allow for a rotation of marketing creative to allow an advertiser to test various approaches for their advertising to see which approaches will work best for the advertiser. Some approaches are done at the level of the publisher, who rotates the display of multiple marketing creatives to each subsequent user as users visit their website.

Other technology exists that allows an advertiser to install specialized software with the publisher to connect the advertiser's sales systems into the advertising systems of the publisher such as, for example, software marketed by Mediaplex.com and Centerport.com. Such systems purport to allow for real-time ad updating for dynamic price changes or inventory availability, as well as impression to click optimization, to determine advertising to click effectiveness.

Still other technology allows advertisers to place referral links within ads instead of direct links to sales pages, and then allow for dynamically changing of the destination of such referral links based on a set of rules as defined by the advertiser. These systems are used by marketing partners to track the click performance of their marketing programs, and are used by marketers to allow them to use different sales pages to determine which such sales pages have the best sales page conversion rate (e.g., Inceptor.com).

Ad serving technology in formats similar to that discussed above is currently being developed for interactive television and television on demand, and to allow media providers running such systems to individually address advertising to each individual customers, thereby allowing the media providers to target advertising individually to each customer.

### SUMMARY OF THE INVENTION

It is an object of the present invention to provide a method and system of tracking individual customer information and behavioral data (including response information and data), to allow for dynamically changing of an advertising marketing offer creative to be used with a subset of a marketing program without requiring publisher participation in the process or requiring the installation of specialized software, to allow for testing of a variety of sales pages to a subset of the marketing program using a referral link engine, and using a set of user defined rules engine to analyze results and automatically selecting the optimal set of materials for use in the marketing program.

It is another object of the present invention, in one aspect, to preferably track results in real-time for the variations and combinations tested.

It is still another object of the present invention to provide a method and a system that tracks individual customer information and behavioral data.

It is yet another object of the present invention to provide such a method and system that incorporates dynamically changing the advertising marketing creative being displayed to the user by means of a media management and data analysis system.

It is a further object of the present invention to allow for the implementation of such a method and system that obviates the need of a media publisher having to install specialized software, install, or rotate various creative to achieve maximum performance.

It is yet a further object of the present invention to provide such a method and system that tests a variety of sales pages to determine which format, text, price, look or other approach produces the most profitable result.

It is still a further object of the present invention to provide such a method and system that tracks data, prepared in real time, and uses pre-determined calculations and rules to identify the optimal advertising combination.

These and other objects and advantages of the present invention are achieved by a method and a system for optimizing the utilization of electronic advertising inventory based on captured data, and patterns of optimal conversion on a subset test group. The method and system includes systematically capturing customer information (which may include, for example, the day/time/date of the visit, the location on the site, channel or other electronic media property, demographic information including physical location, ad format data), as well as partner coding information. The method then passes such information to an analyzer that determines which advertising unit to display, and what follow-up sales process will be used, capturing the customer action information, and preferably continuously analyzing such information against pre-determined rule-sets to determine whether to remove the advertising unit from the advertising marketing mix.

The method and system of the present invention also preferably utilizes a variable advertising creative within a static delivery vehicle. This may take the form of different images loading within a banner, button, ad box, pop-up or pop-under web-page, or different email pages loaded within a secure or unsecure frameset within an email browser, or could be a combination of video and audio uniquely streamed into a uniquely addressable set-top box or other television control device in the case of interactive television. The systems for displaying the multiple creatives within the these various media formats is dependent upon the technology available to the site and generally available to consumers at large. An example of such format for online and email advertisements would be the use of a frameset to deliver an advertisement instead of sending the image directly. The frameset allows the system operator to dynamically deliver a specific version of the offer without the publisher being required to deploy multiple creative formats. An aspect of this invention includes the use of secure and non-secure framesets within emails to display multiple versions of email or sales pages within a single email frameset to allow for testing of multiple offers to consumers.

While the present invention is discussed primarily in the context of marketing of a service over a network, such as the Internet, the present invention can be adopted to any electronic marketing process having an electronically based advertising unit, an electronic sales process, and a sales process that can be linked electronically to such a system as in, for example, an inbound sales phone center tied into the online sales system, and interactive television.

### BRIEF DESCRIPTION OF THE DRAWINGS

FIG. 1 is an exemplary top level depiction of the present invention;

FIG. 2 is an exemplary depiction of an electronic advertiser of the invention of FIG. 1;

FIG. 3 is an exemplary depiction of a customer system of the invention of FIG. 1;

FIG. 4 is an exemplary depiction of a marketing optimizer of the invention of FIG. 1;

FIG. 5 is an exemplary depiction of customer traffic flow in one aspect of the method of the present invention;

FIG. 6a is a process flow diagram depicting exemplary steps and data tests conducted prior to initiating use of a marketing optimizer of the present invention; and

FIG. 6b is a continuation of the process flow diagram of FIG. 6a, the flow diagram showing an exemplary version of the internal logic used by the marketing optimization system of FIG. 1.

### DETAILED DESCRIPTION OF THE INVENTION

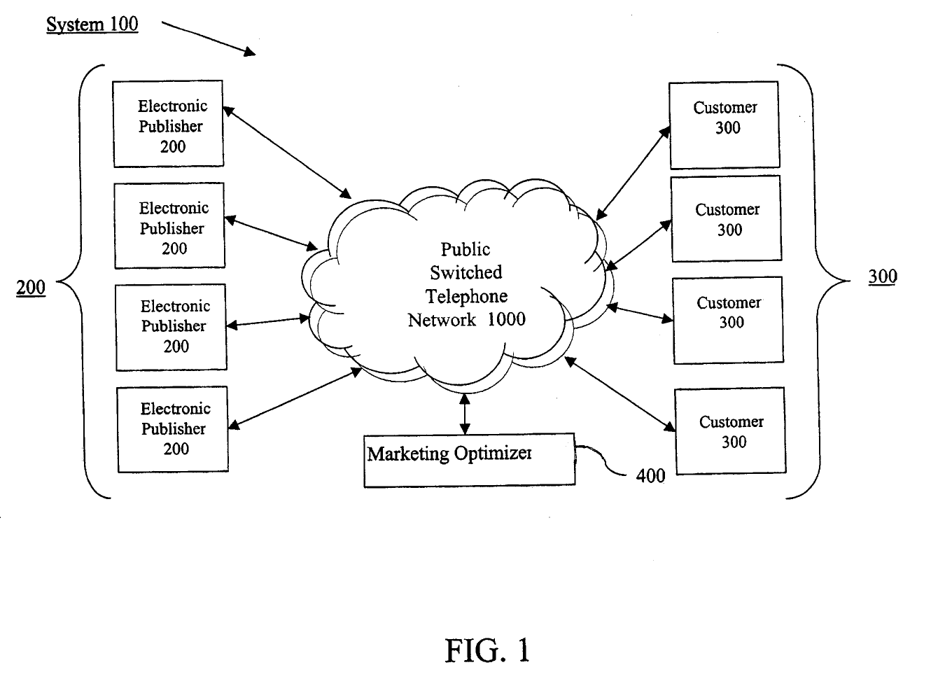

Referring to the drawings and, in particular, to FIG. 1, there is shown one embodiment of a system of the present invention generally represented by reference numeral 100. System 100 provides the system operator with a methodology for capturing customer information. The system 100 passes such information on to an analyzer that determines which advertising unit to display, and what follow-up sales process will be used. The system also captures the customer action information, and continuously analyzes such information against pre-determined rule-sets to determine whether to remove such advertising unit from the advertising marketing mix.

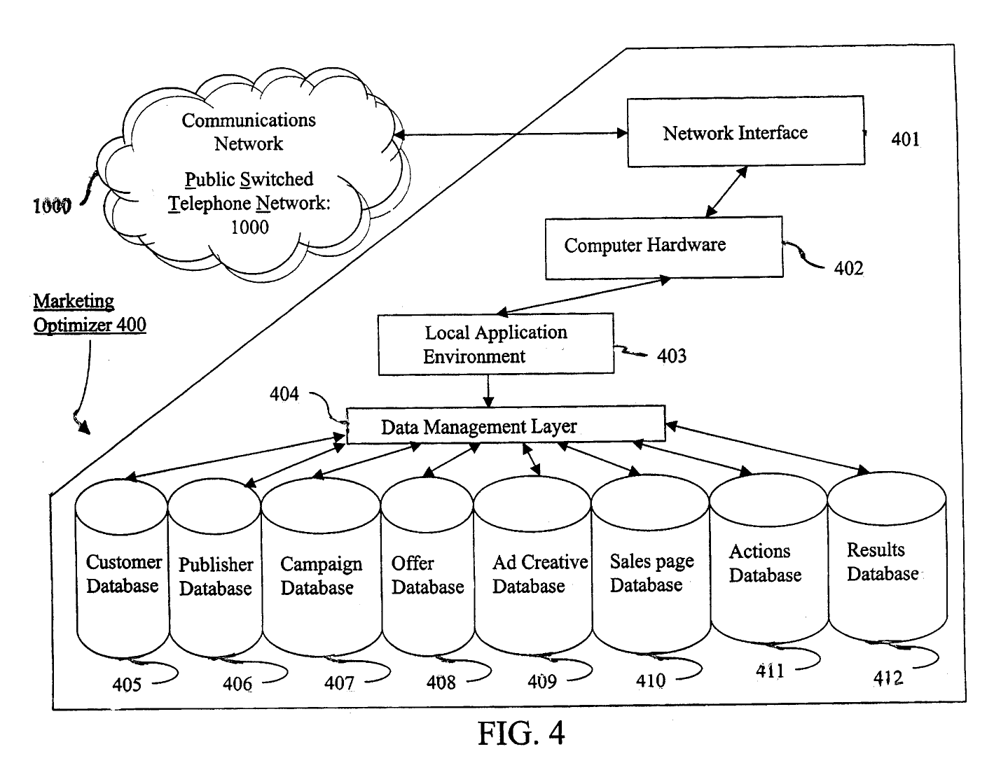

System 100 has at least one electronic advertiser publisher 200; a communications network 1000, in this particular embodiment a public switched telephone network (hereinafter PSTN); one or more customer systems 300; and a marketing optimizer 400. Marketing optimizer 400 includes a Data management layer 404 (see FIG. 4). Marketing optimizer 400, electronic publishers 200, and customer system 300 are preferably connected to communications network 1000 through two-way communications links.

Although depicted in FIG. 1 as a PSTN, communications network 1000 can include a computer network such as the Internet or a LAN. Communications network 1000 can also include wireless, paging, cable networks, other communications networks, or any combinations thereof, for at least portions of the communication network 1000 used by the system 100.

Operators of system 100 may input multiple marketing and sales creative formats into a sales and marketing creative database, and set rules for the quantity of visits to each combination. Electronic publishers 200 send their customers advertising impressions, in the form of, for example, emails, onsite graphical advertisements, interstitial ads (including pop-ups and pop-unders) and other online advertising formats. Electronic publisher 200 is preferably given a master campaign link that is set up to select various marketing and sales creatives from a set of marketing and sales creatives approved for the campaign, and appropriately tests each marketing and sales creative. The electronic publisher 200 can use the master campaign link repeatedly. However, each time it is used, the actual marketing and/or sales creative that the consumer sees is preferably, though not necessarily, different based on the marketing optimizer 400. The results of which ads were viewed, which were clicked on, and which sold products/services, are stored in marketing optimizer 400 database. The database uses the stored data to calculate which combination of marketing and sales creatives produced the highest overall result, according to various metrics.

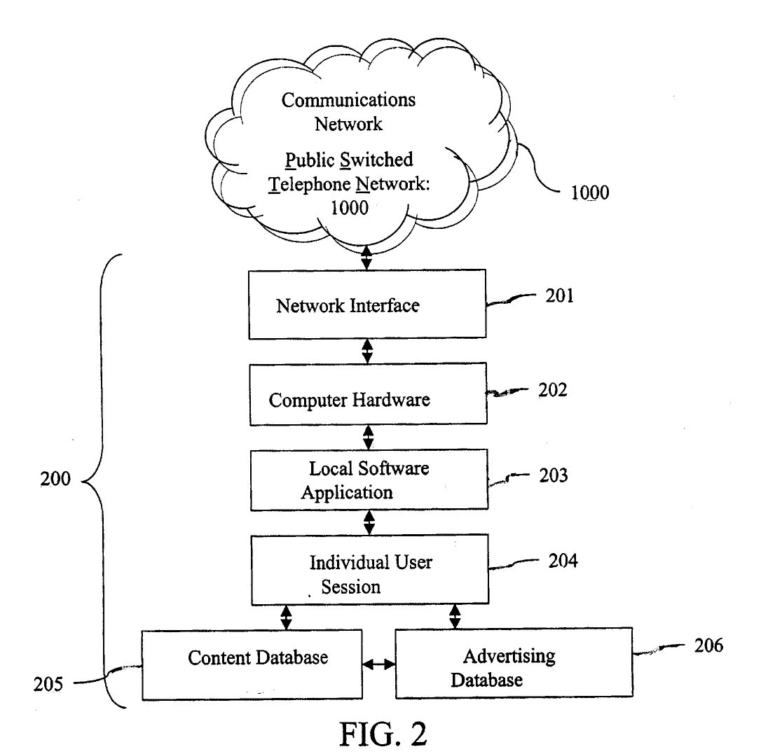

An exemplary embodiment of electronic publisher 200 is depicted in FIG. 2. Customer system 300 initiates an individual user session 204 on electronic publisher 200. Electronic publisher 200 can be an internet server, a specialized media server, a personal computer, an Internet appliance, a handheld information device, a cell phone, or other devices that can communicate electronic information and is serving advertising impressions. In an aspect hereof, a user accesses system 100 through communications network 1000 and local network interface 201 connected to computer hardware 202. Local software application 203 preferably creates a unique individual user session 204 on electronic publisher 200. Individual local session 204 requests specific content from a content database 205 accessible to electronic publisher 200, which in turn calls advertising impressions from an advertising database 206.

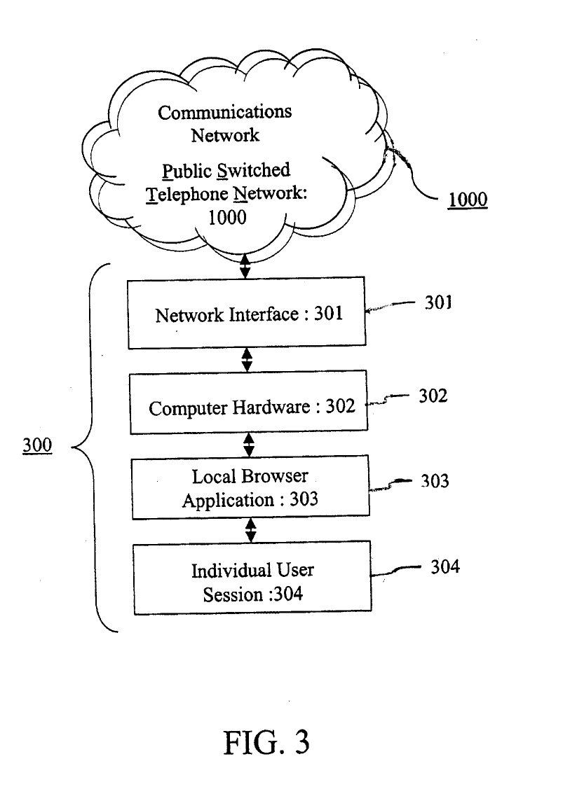

FIG. 3 illustrates an exemplary embodiment of customer system 300. Customer initiates a user session 304 on computer hardware 302 via (preferably) a local browser application 303 that connects computer hardware 302, using a network interface 301, with communications network 1000.

FIG. 4 illustrates an aspect of marketing optimizer 400. Various data repositories 405 through 412 within marketing optimizer 400 are accessed and controlled by data management layer 404. Data management layer 404 acts to control the flow, access, and storage of the data used by system 100. Data management layer 404 may reside within a local application environment 403, which runs on associated computer hardware 402. A network interface 401 interfaces and communicates with the communications network 1000.

Although expressed as hardware, the computer platform supporting the local application environment 402 may employ software, hardware or a combination thereof, to facilitate the operations of the marketing optimizer 400.

In operation, ad and data requests and responses to and from electronic publisher 200 are routed to marketing optimizer 400. The request is fulfilled or the data is stored by marketing optimizer 400 through data management layer 404. The fulfillment or storage is preferably based on the availability of the requested data or the type of data to be provided or stored.

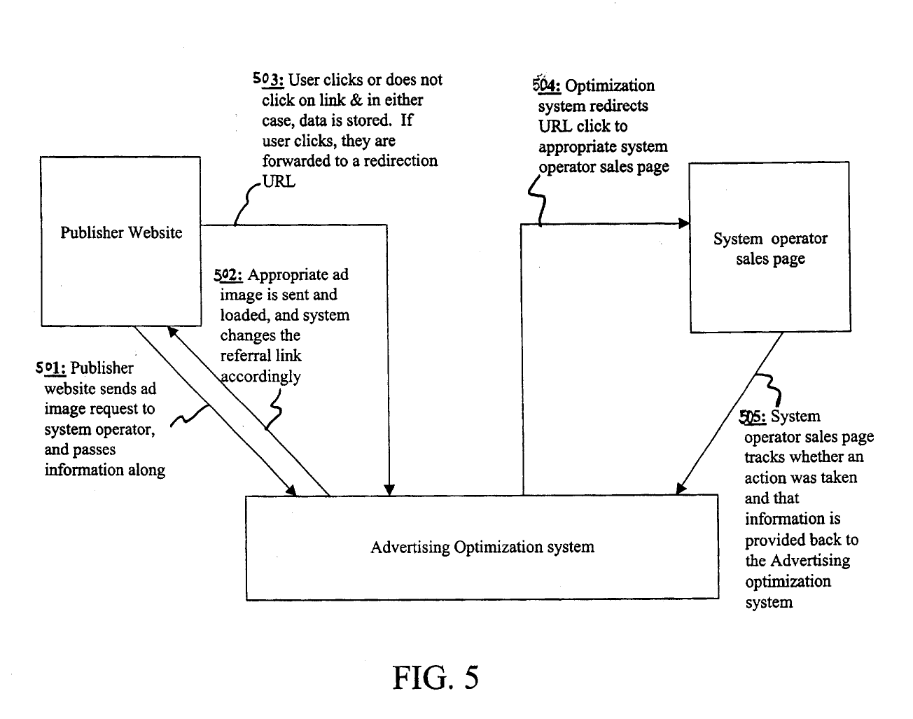

FIG. 5 illustrates an exemplary customer data transaction process that utilizes marketing optimizer 400. In an aspect hereof, the consumer is initially viewing or on a publisher website (e.g., electronic publisher) or receives an email from the publisher and the website/email sends a web page to the user, which creates a request on the part of the user from the marketing optimizer system for a particular ad to display (Step 501). Marketing optimizer 400 sends the appropriate advertising impression to the user's machine and sets the referral link used by that electronic publisher 200 to point to a specific sales follow-up page (which may require the use of a cookie or other message to match the appropriate sales follow-up page with the appropriate advertising impression) (Step 502). The user may either click or not click on the link. In either case, the data is stored. In one aspect, the default is preferably configured such that the user does not click, and a counter is increased if the user does click (Step 503). For users that click, they are forwarded to the appropriate follow-up page (Step 504). When users get to the sales page, the default is set to no-action, whereas if the user purchases, a counter is increased by one (Step 505).

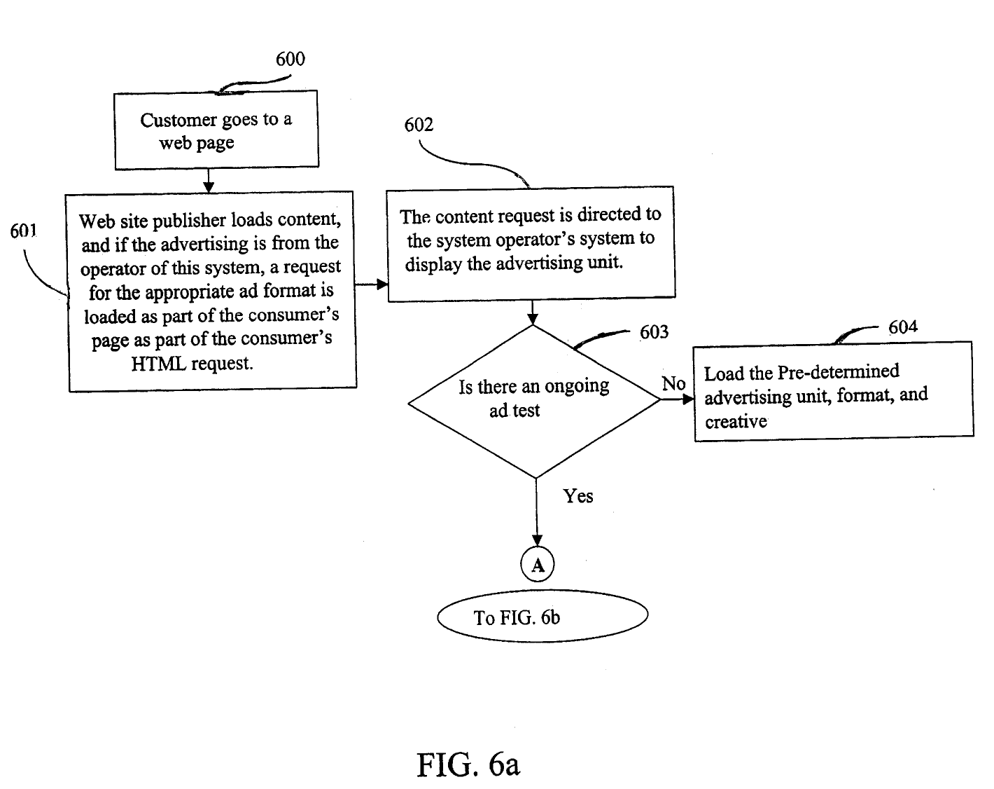

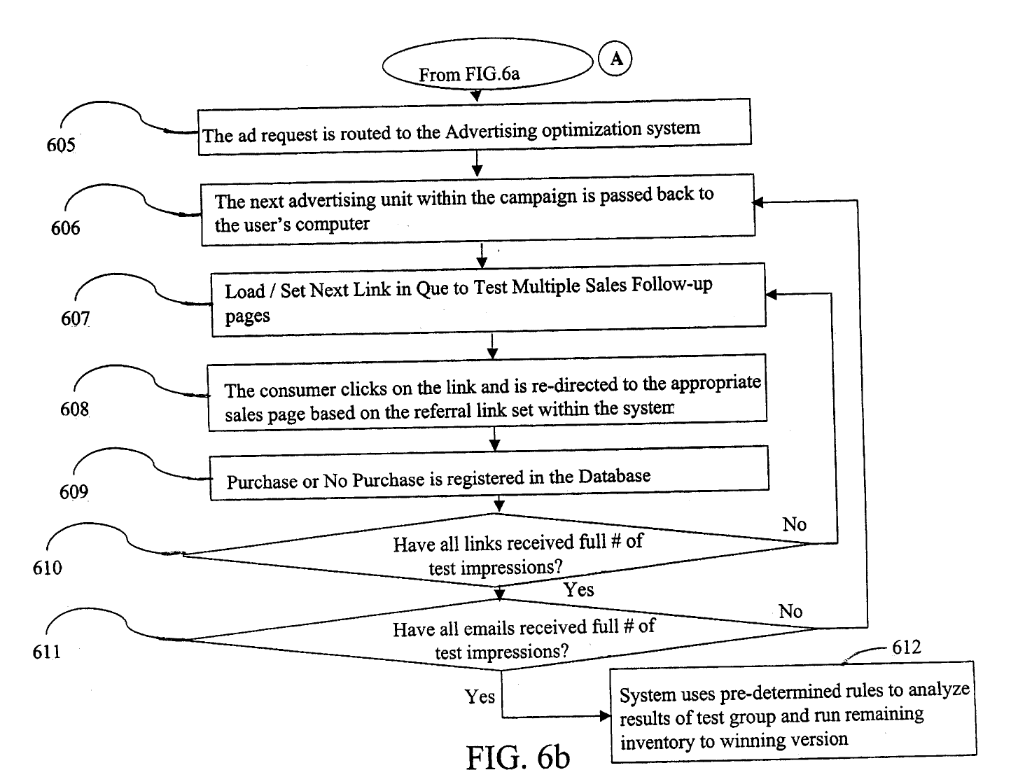

FIG. 6a is an exemplary process flow diagram illustrating certain steps marketing optimizer 400 uses to determine which version of the advertisement and which version of the sale page, to use in a particular campaign. In step 600, the customer goes to a web page at the electronic publisher's 200 website. In step 601, electronic publisher's 200 website loads content from its internal content database 205 and loads an advertising HTML request in the page based on advertising database 206. In step 602, this advertising request is routed to the computer system of the company that is operating this process. In step 603, it is determined whether there is an ongoing advertising test. If it is determined that there is not an ongoing test, the pre-determined advertising unit is loaded in step 604. Otherwise, if there is an ongoing advertising test, the process moves on to FIG. 6b step at 605.

FIG. 6b is a continuation of the process flow diagram started in FIG. 6a. In step 605 of FIG. 6b, the ad request is routed to marketing optimizer 400. At step 606, a next advertising unit in the campaign is passed back to the consumer's computer. In step 607, the marketing optimizer 400 sets the referral link used in that particular advertising creative to refer to a particular page being tested. In step 608, the consumer clicks on the referral link and is re-directed to the appropriate sales page based on the referral link as set in the marketing optimization system. If the user does not click on the link, that fact is registered (preferably by default) based on the number of impressions to the ad versus the number of impressions to the follow-up page. Thus, either way, the action or inaction is calculated into the total conversion metrics of that particular ad format, which is captured in step 609.

In step 610, a determination is made whether all the individual links in the test program have received a full number of test impressions, as defined by the user. If all of the links have not received a full number of test impressions, then the process returns to step number 607 and recursively repeats until each link has had a full number of test impressions. Once each link has received a full number of test impressions, in step 611, a determination is made whether all emails have received a full number of test impressions. If all emails have not received a full transfer of test impressions, then the process of FIG. 6b reverts back to step 606, and continues in repeating cycles until all emails have received all the required test impressions against each potential test link. Once all emails have received a full number of test impressions, the process proceeds to step 612. In step 612, the system analyzes the results of the individual test combinations of advertising impressions and sales page links to determine the most successful combination and then uses that successful combination to send to any additional advertising impressions from the marketing programs.

It should be understood that the foregoing is only illustrative of the present invention. Various alternatives, modifications, and variances can be made by those skilled in the art without departing form the present invention. Accordingly, the present invention is intended to embrace all such alternatives, modifications, and variances.

What we claim is:

1. A system of optimizing a marketing program, said system comprising:
an electronic publisher for sending an ad request;
a marketing optimizer, in response to the ad request, fulfilling the ad request by providing an ad impression; and
a customer device for receiving the ad impression and, depending on a response to the ad impression, receiving a sales process, wherein the marketing optimizer analyzes the response to determine an optimal marketing program.

2. The system of claim 1, wherein the electronic publisher, the marketing optimizer, and the customer device are connected by a communication link.

3. The system of claim 2, wherein the communication link is selected from a group consisting of an intranet, an internet, local area network, token ring, terrestrial and satellite communications systems, and any combinations thereof.

4. The system of claim 1, wherein the ad impression comprises a variable advertising creative.

5. The system of claim 1, wherein the customer device is selected from a group consisting of a personal computer, a mobile phone, a handheld computer, a personal digital assistant (PDA), an internet browser, an email browser, a television control device, and any combinations thereof.

6. The system of claim 1, wherein the marketing optimizer comprises a data manager layer for controlling a flow, access, and storage of data used by the system.

7. The system of claim 1, wherein the marketing optimizer has access to stored advertising data.

8. A method of optimizing a marketing program, said method comprising:
sending an ad request from an electronic publisher;
fulfilling, by a marketing optimizer, the ad request by providing an ad impression in response to the ad request;
receiving the ad impression at a customer device;
receiving a sales process, at least in part, based on a response to the ad impression; and
analyzing the response to determine an optimal marketing program.

9. The method of claim 8, wherein the analyzing is accomplished by the market optimizer.

10. The method of claim 8, further comprising determining whether a marketing optimization is in progress.

11. The method of claim 8, further comprising recursively receiving an ad impression until a marketing criteria is satisfied.

12. The method of claim 8, further comprising determining whether a purchase is executed in response to the sale process.

13. The method of claim 12, further comprising storing said determination.

14. The method of claim 12, wherein said analyzing uses the determination of whether the purchase is executed.

15. The method of claim 8, further comprising connecting the electronic publisher, the marketing optimizer, and the customer device by a communication link.

16. The method of claim 8, wherein the ad impression comprises a variable advertising creative.

17. The method of claim 8, wherein the customer device is selected from a group consisting of a personal computer, a mobile phone, a handheld computer, a personal digital assistant (PDA), an internet browser, an email browser, a television control device, and any combinations thereof.
